(19) United States
(12) Patent Application Publication
(10) Pub. No.: US 2025/0219297 A1
(43) Pub. Date: Jul. 3, 2025

(54) ANTENNA APPARATUS AND COMMUNICATION DEVICE

(71) Applicant: HUAWEI TECHNOLOGIES CO., LTD., Shenzhen (CN)

(72) Inventors: Jinsong LV, Shanghai (CN); Tao PU, Shanghai (CN); Jinju WANG, Dongguan (CN); Jia LV, Shanghai (CN); Weihong XIAO, Dongguan (CN)

(21) Appl. No.: 19/083,737

(22) Filed: Mar. 19, 2025

Related U.S. Application Data
(63) Continuation of application No. PCT/CN2023/117479, filed on Sep. 7, 2023.

(30) Foreign Application Priority Data
Sep. 20, 2022 (CN) 202211145858.8

(51) Int. Cl. H01Q 21/00; H01Q 1/24; H01Q 3/46; H01Q 15/00; H01Q 15/08

(52) U.S. Cl. CPC H01Q 21/0031; H01Q 3/46; H01Q 15/0086; H01Q 15/08; H01Q 1/246

(57) ABSTRACT

Embodiments of this application provide an antenna apparatus and a communication device. The antenna apparatus includes a lens unit and a plurality of radiating elements. The plurality of radiating elements are arranged in an array to form an array structure. There are a plurality of side regions on a circumferential outer side of the array structure, and the lens unit is disposed in at least one of the plurality of side regions, so that an electromagnetic wave signal radiated from a side surface of the radiating element can be radiated after passing through the lens unit. Correspondingly, an electromagnetic wave signal may also be received by the radiating element after passing through the lens unit.

### CROSS-REFERENCE TO RELATED APPLICATIONS

This application is a continuation of International Application No. PCT/CN2023/117479, filed on Sep. 7, 2023, which claims priority to Chinese Patent Application No. 202211145858.8, filed on Sep. 20, 2022. The disclosures of the aforementioned applications are hereby incorporated by reference in their entireties.

### TECHNICAL FIELD

This application relates to the field of antenna technologies, and in particular, to an antenna apparatus and a communication device.

### BACKGROUND

With development of communication technologies, users have increasingly high requirements on a transmission speed and a transmission bandwidth of a network, and the modern society has fully entered the information era. A base station antenna is an important part of mobile communication, and higher requirements are posed on performance of the antenna in terms of a bandwidth, a gain, directionality, and the like. A phased array antenna is a new form of antenna developed based on an array antenna, and can use a phase shifter to control a feeding phase of a radiating element in the array antenna, to change a shape of a directivity pattern and achieve an objective of beam scanning. The phased array antenna can implement high-speed and accurate beam scanning, and therefore arouses widespread attention.

The phased array antenna usually includes a plurality of radiating elements and a plurality of feeding networks. The plurality of radiating elements are arranged in an array, and each radiating element is electrically connected to a feeding network corresponding to the radiating element, so that the radiating element can receive or send a radio frequency signal through a feeding unit corresponding to the radiating element. To meet a requirement for wide-angle scanning of the antenna, the phased array antenna may further include a metamaterial layer, and the metamaterial layer is disposed on an entire aperture surface of the antenna. In other words, the metamaterial layer may be parallel to a radiating surface of the radiating element arranged in an array, is located above the radiating surface of the radiating element, and implements wide-angle scanning of the phased array antenna by using electromagnetic performance of a metamaterial. However, an electromagnetic wave signal radiated or received by the radiating element through the radiating surface needs to penetrate the metamaterial layer. This causes a high thermal loss and a gain loss.

Therefore, a low-loss antenna apparatus that can implement wide-angle scanning is urgently needed to meet a communication requirement.

### SUMMARY

This application provides an antenna apparatus and a communication device. The antenna apparatus has advantages of a low loss and low costs, and can implement wide-angle scanning, thereby improving performance of the antenna apparatus.

A first aspect of this application provides an antenna apparatus, including a lens unit and a plurality of radiating elements. The plurality of radiating elements are spaced from each other and arranged in an array to form an array structure, the array structure includes at least four columns, and each column includes at least one radiating element.

The antenna apparatus further includes a plurality of side regions located on a circumferential outer side of the array structure, and the lens unit is disposed in at least one of the plurality of side regions, so that an electromagnetic wave signal radiated from a side surface of the radiating element can be radiated after passing through the lens unit. Correspondingly, an electromagnetic wave signal may be received by the radiating element after passing through the lens unit.

When the electromagnetic wave signal passes through the lens unit, the lens unit refracts the electromagnetic wave, and changes an angle at which the electromagnetic wave signal is emitted from the lens unit, so that an electromagnetic wave beam can be broadened, that is, a beam that can be radiated or received by the radiating element is broadened, thereby implementing wide-angle scanning of the antenna apparatus and improving performance of the antenna apparatus. A purpose of wide-angle scanning is achieved by using the lens unit, and a thermal loss and a gain loss caused when the electromagnetic wave passes through the lens unit are relatively low. Under a condition of implementing wide-angle scanning, a thermal loss of the antenna apparatus can be effectively reduced. In addition, the lens unit is located in the side region, and can effectively use energy of an electromagnetic wave radiated by the radiating element in a side direction, thereby improving a side radiation capability of the antenna apparatus. In addition, compared with a metamaterial structure layer or another mechanical part disposed on an aperture surface with a relatively large area, the lens unit disposed in the side region requires a relatively small area and has relatively low costs. This helps reduce manufacturing costs of the antenna apparatus under a condition of implementing wide-angle scanning.

In an embodiment, in a height direction of the array structure, two ends of the lens unit are respectively located on upper and lower sides of radiating surfaces of the plurality of radiating elements, so that an electromagnetic wave signal radiated by the radiating element in a side direction can better pass through the lens unit, thereby further implementing wide-angle scanning.

In an embodiment, the plurality of side regions include a first side region and a second side region opposite to each other, the first side region and the second side region are distributed in a width direction of the array structure, and lens units are separately disposed in the first side region and the second side region. An electromagnetic wave signal radiated by the antenna apparatus can be broadened in a width direction, to implement wide-angle scanning in the direction. In addition, symmetry of a radiation characteristic of the antenna apparatus can be ensured. This is convenient for use and implementation.

In an embodiment, the lens unit includes a dielectric lens, and the lens unit may be an optical lens made of a dielectric material such as glass or plastic. Costs are low, and implementation and manufacturing are easy.

In an embodiment, the lens unit includes an electromagnetic metamaterial layer, and the electromagnetic metamaterial layer may have relatively low costs and a relatively light weight. Under a condition of implementing wide-angle scanning, this further helps reduce a weight and costs of the antenna apparatus.

In an embodiment, there are a plurality of electromagnetic metamaterial layers, and the plurality of electromagnetic metamaterial layers are stacked, to improve flexibility of setting a structure of the lens unit, so as to meet different design requirements and application scenarios.

In an embodiment, the lens unit completely covers the array structure in a length direction of the array structure. In other words, the lens unit can completely cover an outer side of the array structure in the length direction, to fully utilize energy of electromagnetic waves radiated by the plurality of radiating elements in the array structure in a side direction. This helps further improve a broadening effect of the antenna apparatus, to implement scanning at a wider angle.

In an embodiment, the lens unit includes a plurality of lens substructures, the plurality of lens substructures are distributed in the length direction of the array structure and spaced from each other, and at least some lens substructures are opposite to the radiating element, to ensure that an electromagnetic wave signal radiated by the radiating element is radiated through the lens substructure, or an electromagnetic wave signal is received by the radiating element through the lens substructure. Under a condition of implementing wide-angle scanning, this helps reduce a size of the lens unit, and helps reduce costs, a weight, and the like.

In an embodiment, in the height direction of the array structure, a distance between a top surface of the lens unit and the radiating surface of the radiating element and a distance between a bottom surface of the lens unit and the radiating surface of the radiating element each are 0.15 to 1.0 time a wavelength. An electromagnetic wave signal radiated by the radiating element in a side direction can better pass through the lens unit. This further helps implement wide-angle scanning, and energy of an electromagnetic wave radiated by the radiating element in the side direction can be more effectively used.

In an embodiment, the plurality of radiating elements are spaced from each other to form at least four columns, and each column includes at least one radiating element. In this way, the antenna apparatus has a relatively large capacity and a relatively large quantity of ports, and has wide practicability.

In an embodiment, the apparatus further includes a reflection plate, and the radiating element is disposed on the reflection plate. The reflection plate can reflect an electromagnetic wave signal, to improve receiving sensitivity of the antenna apparatus for the electromagnetic wave signal. For example, the reflection plate can reflect electromagnetic wave signals to aggregate the electromagnetic wave signals on a radiating element of a receive antenna, so that a receiving or transmitting capability of the antenna apparatus can be enhanced.

In an embodiment, the apparatus further includes a radome, and the radome covers the array structure. The radome may protect the mechanical parts of the antenna apparatus from being affected by an external environment. The radome has a good electromagnetic wave penetration characteristic in electrical performance, and can withstand impact of an external harsh environment in mechanical performance. The radome protects the mechanical parts of the antenna apparatus, so that damage inside the antenna apparatus due to dust or water can be effectively avoided.

A second aspect of this application provides a communication device, including at least a pole, a grounding apparatus, and the antenna apparatus according to any one of the foregoing implementations. The antenna apparatus is disposed on the pole, and the antenna apparatus is electrically connected to the grounding apparatus. The antenna apparatus is included, and the antenna apparatus can effectively reduce a loss and costs under a condition of implementing wide-angle scanning, thereby improving communication performance of the communication device, and helping reduce a thermal loss and costs of the communication device.

### BRIEF DESCRIPTION OF DRAWINGS

FIG. 1 is a diagram of a structure of an antenna system in a communication device according to an embodiment of this application;

FIG. 2 is a diagram of a frame structure of an antenna apparatus according to an embodiment of this application;

FIG. 3 is a schematic side view of an array structure in an antenna apparatus according to an embodiment of this application;

FIG. 4 is a diagram of a structure of an antenna apparatus according to an embodiment of this application;

FIG. 5 is a schematic side view of an antenna apparatus according to an embodiment of this application;

FIG. 6 is a diagram of a structure of another antenna apparatus according to an embodiment of this application;

FIG. 7 is a diagram of a structure of a lens unit in another antenna apparatus according to an embodiment of this application; and

FIG. 8 is a schematic side view of another antenna apparatus according to an embodiment of this application.

### DESCRIPTION OF REFERENCE NUMERALS

100: antenna system;
101: antenna apparatus;
10: array structure;
11: radiating element; 111: radiating surface;
20: lens unit;
20a: first lens unit; 20b: second lens unit;
21a and 21b: electromagnetic metamaterial layer; 211: substrate; 212: metamaterial structure pattern;
31: front region;
32: rear region;
33a: first side region; 33b: second side region; 33c: third side region; 33d: fourth side region;
40: phase shifter;
51: transmission component; 52: calibration network;
61: combiner; 62: filter;
70: reflection plate;
80: radome;
90: antenna connector;
201: fastening bracket;
301: pole;
401: connecting piece;
501: grounding apparatus.

### DESCRIPTION OF EMBODIMENTS

Terms used in embodiments of this application are merely used to explain embodiments of this application, but are not intended to limit this application.

Unless otherwise specified in the context, in the entire specification and claims, the term “include (comprise)” and other forms of the term, for example, the third person singular form “includes (comprises)” and the present participle form “including (comprising)” are interpreted as “open and inclusive”, that is, “include, but not limited to”. In descriptions of the specification, terms such as “one embodiment”, “some embodiments”, “example embodiments”, “example”, or “some examples” are intended to indicate that features, structures, materials, or characteristics related to the embodiments or examples are included in at least one embodiment or example of the present disclosure. The foregoing schematic representations of the terms do not necessarily mean a same embodiment or example. In addition, the features, structures, materials, or characteristics may be included in any one or more embodiments or examples in any appropriate manner.

In addition, in this application, position terms such as “front” and “rear” are defined relative to positions of components in the accompanying drawings. It should be understood that these position terms are relative concepts used for relative description and clarification, and may correspondingly change based on changes in the positions of the components in the accompanying drawings.

A phased array antenna is a new form of antenna developed based on an array antenna. The phased array antenna uses a phase shifter to control a feeding phase of a radiating element arranged in an array in the antenna, to change a shape of a directivity pattern and achieve an objective of beam scanning. The phased array antenna can implement high-speed and accurate beam scanning, and therefore arouses widespread attention.

With rapid development of wireless communication technologies, higher requirements are posed on performance indicators of the phased array antenna. For example, a wider operating band and a larger scanning range are two most important features required by the phased array antenna. When a wideband wide-angle scanning phased array is designed, a designed radiating element with a wideband wide beam is usually used, and an array arrangement manner is properly selected, to implement a wideband wide-angle scanning characteristic of the array. However, as a scanning angle of a main beam of the phased array increases, a beam scanning characteristic of the phased array is affected by a problem of an increase in a scanning loss. A mutual coupling effect between adjacent array elements in the phased array and a radiation characteristic of the array element are two main factors that cause fast gain attenuation.

In a related technology, for a problem that gain attenuation is severe when phased array scanning is performed at a large angle, there are roughly the following three solutions: 1. A phased array element structure with a wide beam radiation characteristic is designed. In this case, a half-power beamwidth of an element may be used as a key parameter for evaluating a beam scanning range. 2. Wide beam scanning is implemented by designing a decoupling feeding network. 3. An electromagnetic coupling effect between array elements is improved. In an embodiment, mutual coupling between array elements may be reduced by adding a decoupling wall between the array elements, introducing a polarization conversion patch, changing inherent field distribution of each array element, and the like. However, although the foregoing three solutions can improve a radiation characteristic of the array element or reduce a mutual coupling effect between adjacent array elements to some extent, a scanning angle that can be achieved is still relatively small. This limits working efficiency of the phased array antenna in wideband wide-angle scanning.

In the related technology, wide-angle scanning of the phased array antenna is also achieved by loading an electromagnetic metamaterial structure. For example, an electromagnetic metamaterial layer is disposed on an aperture surface of a radiating element array, and the metamaterial structure layer is located above a radiating surface of a radiating element, is opposite to the radiating element in the array, and covers the radiating surface. A scanning angle width of the phased array antenna is expanded by using electromagnetic performance of the metamaterial structure layer. However, an electromagnetic wave signal radiated by the radiating element needs to be radiated through the electromagnetic metamaterial layer. Correspondingly, an electromagnetic wave signal needs to be received by the radiating element after passing through the electromagnetic metamaterial layer. This causes a high thermal loss and a gain loss. In addition, costs of covering the entire aperture surface with the metamaterial structure layer are relatively high, and radiation energy on a side (located on the periphery of the radiating surface of the radiating element) of the radiating element cannot be effectively improved and utilized.

Based on this, embodiments of this application provide an antenna apparatus with a low loss, low costs, and a wide-angle scanning characteristic, to effectively improve a side radiation capability of the antenna apparatus.

Embodiments of this application further provide a communication device including the foregoing antenna apparatus. The communication device may be a communication base station, for example, may be a public mobile communication base station. The communication base station is used as an example. The communication device may be an interface device for a mobile device to access the internet, and is also a form of a radio station. In a radio coverage region, a radio transceiver station transfers information between the mobile device and the communication base station, that is, a mobile communication switching center.

FIG. 1 is a diagram of a structure of an antenna system in a communication device according to an embodiment of this application.

For example, the communication device is a communication base station. The communication device may include an antenna system 100. The antenna system 100 is a main component for transferring information between the communication base station and a mobile device. The antenna system 100 may include an antenna apparatus 101, a fastening bracket 201, a pole 301, a connecting piece 401, a grounding apparatus 501, and the like. The antenna apparatus 101 is fastened to the pole 301 by using the fastening bracket 201. In actual application, a position and an installation angle of the antenna apparatus 101 on the pole 301 may be adjusted by adjusting a position and an angle of the fastening bracket 201.

The antenna apparatus 101 may be connected to the grounding apparatus 501 through the connecting piece 401, to ensure that the antenna apparatus 101 is grounded. An end that is of the connecting piece 401 and that is connected to the antenna apparatus 101 may be provided with a connector sealing piece, to ensure sealing performance of the connection between the connecting piece 401 and the antenna apparatus 101. Correspondingly, an end that is of the connecting piece 401 and that is connected to the grounding apparatus 501 may also be provided with a connector sealing piece, to ensure sealing performance of the connection between the connecting piece 401 and the grounding apparatus 501.

The connector sealing piece may be any mechanical part that can perform an insulation sealing function. For example, the connector sealing piece may be an insulation sealing tape, for example, a polyvinyl chloride (PVC) insulation tape.

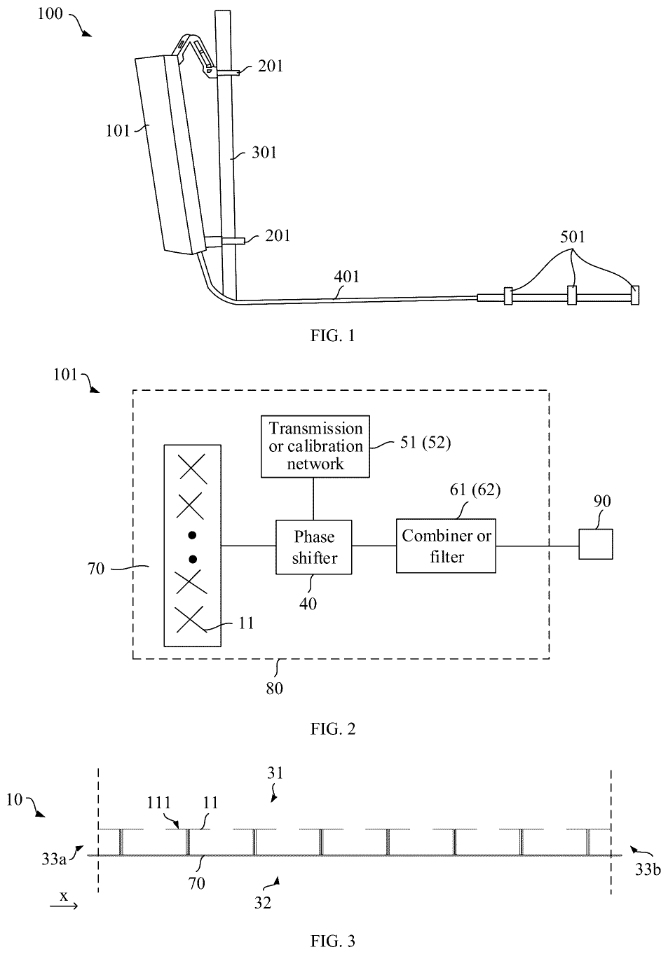

FIG. 2 is a diagram of a frame structure of an antenna apparatus according to an embodiment of this application.

As shown in FIG. 2, the antenna apparatus 101 may include a radiating element 11 and a feeding network (not shown in the figure). The radiating element 11 can effectively radiate or receive an electromagnetic wave signal. The radiating element 11 has a radiating surface, and the electromagnetic wave signal may be radiated through the radiating surface, or the electromagnetic wave signal may be received from through radiating surface. The feeding network feeds a radio frequency signal to the radiating element 11 based on an amplitude and phase, or sends a received electromagnetic wave signal to a communication device, for example, a signal processing unit of a communication base station, based on an amplitude and phase.

In an embodiment, one end of the feeding network is electrically connected to the radiating element 11, and another end of the feeding network is electrically connected to a radio frequency circuit (not shown in the figure), so that a radio frequency signal is transmitted between the radiating element 11 and the radio frequency circuit. For example, the another end of the feeding network is electrically connected to a radio frequency signal port in the radio frequency circuit.

When the antenna apparatus 101 is a transmit antenna, the radio frequency circuit may provide a signal source for the antenna apparatus 101. For example, the another end of the feeding network may be electrically connected to the radio frequency signal port in the radio frequency circuit, so that the radio frequency signal port sends a radio frequency signal, and the radio frequency signal is fed into the radiating element 11 in a form of a current. Then, the radiating element 11 sends the radio frequency signal in a form of an electromagnetic wave, and the electromagnetic wave is received by a receive antenna in a mobile device.

When the antenna apparatus 101 is a receive antenna, the radio frequency circuit may receive a radio frequency signal fed back by the antenna apparatus 101. For example, the radiating element 11 of the antenna apparatus 101 converts a received electromagnetic wave signal into a current signal, and then transmits the current signal to the radio frequency circuit through the feeding network, and then the signal processing unit performs subsequent processing.

The radio frequency circuit may include a remote radio unit (RRU), that is, a part of a remote radio unit radio frequency circuit, and the radio frequency signal port is usually disposed in the remote radio unit. For circuit settings and a working principle of the radio frequency circuit, directly refer to related content in the conventional technology. Details are not described herein.

In embodiments of this application, the antenna apparatus 101 may be a phased array antenna. There are a plurality of radiating elements 11 and a plurality of feeding networks in the antenna apparatus 101. The plurality of radiating elements 11 may be disposed in an array arrangement manner, so that the antenna apparatus 101 forms an array antenna. It should be understood that frequencies of the plurality of radiating elements 11 may be the same, or frequencies of the plurality of radiating elements 11 may be different.

Each radiating element 11 is correspondingly provided with a feeding network, and each radiating element 11 is electrically connected to the respectively corresponding feeding network, so that each radiating element 11 is electrically connected to a radio frequency circuit through the respectively corresponding feeding network, and each radiating element 11 can receive or send a radio frequency signal.

Still as shown in FIG. 2, the antenna apparatus 101 may further include a reflection plate 70. The feeding network and the radiating element 11 are located on the reflection plate 70, and may be located on a same side of the reflection plate 70. A forming material of the reflection plate 70 may be a metal material, for example, may be a metal plate such as aluminum, copper, or silver. The reflection plate 70 can reflect an electromagnetic wave signal, to improve receiving sensitivity of the antenna apparatus 101 for the electromagnetic wave signal. For example, the reflection plate 70 can reflect electromagnetic wave signals to aggregate the electromagnetic wave signals on the radiating element 11 of the receive antenna, so that a receiving or transmitting capability of the antenna apparatus 101 can be enhanced.

In addition, the reflection plate 70 can further play a blocking function, and may block and shield interference caused by another electromagnetic wave from the back (a surface that backs onto the radiating element 11) of the reflection plate 70 to a received signal.

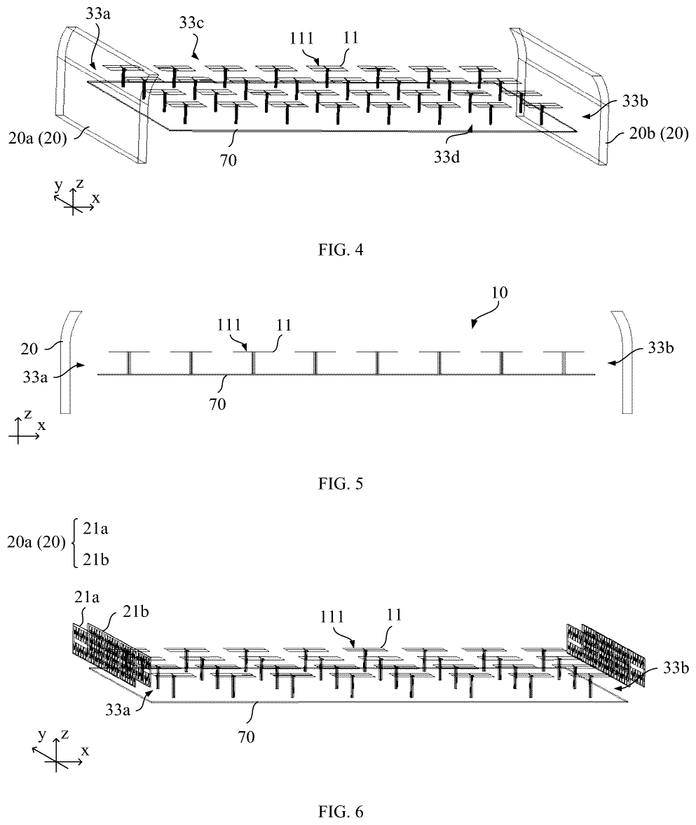

The plurality of radiating elements 11 may be arranged on the reflection plate 70 in an array and spaced from each other. A structure formed by arranging the plurality of radiating elements 11 in an array is an array structure 10 (as shown in FIG. 3 and FIG. 4), that is, the array structure 10 including the radiating elements 11 may be formed on the reflection plate 70. A feeding network is correspondingly disposed on one side of each radiating element 11.

It should be noted that, in the antenna apparatus 101, the array structure including the radiating elements 11 may be formed on one reflection plate 70 or a plurality of reflection plates 70 that are spaced from each other.

The feeding network may include a transmission structure, and the transmission structure of the feeding network is electrically connected to a corresponding radiating element 11. The feeding network may further include a phase shifter 40 connected to the transmission structure. The phase shifter 40 is configured to implement a real-time change of network coverage, and adjust a signal phase to implement electrical downtilt of the array antenna. The phase shifter 40 may be connected to a calibration network 52, to obtain a calibration signal required by the antenna apparatus 101; or the phase shifter 40 may be connected to a transmission component 51, and directions of different radiation beams are implemented by using the transmission component 51.

The feeding network may further include modules configured to extend performance, such as a filter 62 and a combiner 61. The phase shifter 40, the filter 62, the calibration network 52, the transmission component 51, the combiner 61, and the like are not limited in embodiments of this application. For details, refer to related content in the conventional technology.

As shown in FIG. 2, the antenna apparatus 101 may further include a radome 80, and the radome 80 at least covers the array structure 10 including the radiating elements 11. For example, all mechanical parts (including the radiating element 11, the reflection plate 70, the feeding network, and the like) included in the antenna apparatus 101 may be covered by the radome 80. The radome 80 may protect the mechanical parts of the antenna apparatus 101 from being affected by an external environment. The radome 80 has a good electromagnetic wave penetration characteristic in electrical performance, and can withstand impact of an external harsh environment in mechanical performance. The radome 80 protects the mechanical parts of the antenna apparatus 101, so that damage inside the antenna apparatus 101 due to dust or water can be effectively avoided.

Still as shown in FIG. 2, the antenna apparatus 101 further includes an antenna connector 90, and the antenna connector 90 may be connected to the connecting piece 401, so as to implement an electrical connection between the antenna apparatus 101 and the grounding apparatus 501.

FIG. 3 is a schematic side view of an array structure in an antenna apparatus according to an embodiment of this application. FIG. 4 is a diagram of a structure of an antenna apparatus according to an embodiment of this application. FIG. 5 is a schematic side view of an antenna apparatus according to an embodiment of this application.

Refer to FIG. 3. In an embodiment of the application, the plurality of radiating elements 11 are arranged on the reflection plate 70 in an array, and the plurality of radiating elements 11 arranged in an array form an array structure 10. It should be noted that, in an embodiment of the application, a quantity of radiating elements 11 included in each array structure 10 and an arrangement manner of the radiating elements 11 are not limited, and may be selected and set based on a requirement in actual application.

For example, as shown in FIG. 4, the plurality of radiating elements 11 may be arranged in an array in a crosswise manner, so that the formed array structure 10 may be square. For example, the array structure 10 is rectangular.

For example, in an embodiment, the plurality of radiating elements 11 are arranged into four columns and spaced from each other, and each column includes at least one radiating element 11. As shown in FIG. 4, a rectangular array structure 10 in FIG. 4 is formed. Alternatively, the plurality of radiating elements 11 may be arranged into more than four columns and spaced from each other, for example, six columns, eight columns, or nine columns, so that the antenna apparatus 101 has a relatively large capacity and a relatively large quantity of ports, and has wide practicability.

Certainly, in some other examples, the radiating elements 11 may alternatively form the array structure 10 in another array arrangement manner. In embodiments of this application, an example in which the plurality of radiating elements 11 are arranged in a crosswise manner to form a square array structure 10 is used for description.

The array structure 10 may have a length direction, for example, a y direction in FIG. 4. The array structure 10 may have a width direction, for example, an x direction in FIG. 4. The radiating surface 111 may be parallel to a plane in which the length direction and the width direction of the array structure 10 are located. The array structure 10 may further have a height direction, for example, a z direction in FIG. 4. The height direction may be perpendicular to the radiating surface 111 of the radiating element 11.

With reference to FIG. 3 and FIG. 4, the antenna apparatus 101 may be divided into a front region 31, a rear region 32, and a plurality of side regions. The front region 31 covers an aperture surface of the array structure 10. The front region 31 is a region facing radiating surfaces 111 of the plurality of radiating elements 11. The front region 31 may be parallel to the radiating surfaces 111. In other words, the front region 31 is located above the radiating surfaces 111 in a height direction of the array structure 10.

The rear region 32 is opposite to the front region 31. In other words, the rear region 32 is a region facing away from the radiating surfaces 111 of the plurality of radiating elements 11. The rear region 32 may also be parallel to the radiating surfaces 111, and the rear region 32 is located below the radiating surfaces 111 in the height direction of the array structure 10.

The side region is located on a circumferential outer side of the array structure 10. For example, there are four side regions on the circumferential outer side of the array structure 10. That is, the side region is located on a circumferential outer side of a whole formed by the plurality of radiating elements 11. For example, as shown in FIG. 4, the plurality of side regions include a first side region 33a, a second side region 33b, a third side region 33c, and a fourth side region 33d. The first side region 33a, the second side region 33b, the third side region 33c, and the fourth side region 33d are disposed around the array structure 10.

Still as shown in FIG. 4, the antenna apparatus 101 may further include a lens unit 20, and the lens unit 20 can transmit an electromagnetic wave signal. The lens unit 20 is disposed in a side region, that is, the lens unit 20 may be disposed in at least one of the plurality of side regions. In other words, the lens unit 20 is located on the circumferential outer side of the array structure 10, that is, the lens unit 20 is located on a side surface of the plurality of radiating elements 11. An electromagnetic wave signal radiated from the side surface of the radiating element 11 (an outer circumferential side of the radiating surface 111) may be radiated after passing through the lens unit 20. Correspondingly, an electromagnetic wave signal may also be received by the radiating element 11 after passing through the lens unit 20.

When the electromagnetic wave signal passes through the lens unit 20, the lens unit 20 refracts the electromagnetic wave signal, and changes an angle at which the electromagnetic wave signal is emitted from the lens unit 20, so that a beam of the electromagnetic wave can be widened, that is, a beam that can be radiated or received by the radiating element 11 is widened, thereby implementing wide-angle scanning of the antenna apparatus 101 and improving performance of the antenna apparatus 101. A purpose of wide-angle scanning is achieved by using the lens unit 20. An electromagnetic characteristic of the lens unit 20 is relatively low, and a thermal loss and a gain loss caused when the electromagnetic wave signal passes through the lens unit 20 are very low. Under a condition of implementing wide-angle scanning, a thermal loss of the antenna apparatus 101 can be effectively reduced.

In addition, the lens unit 20 is located in the side region, and can effectively use energy of an electromagnetic wave radiated by the radiating element 11 in a side direction, thereby improving a side radiation capability of the antenna apparatus 101. In addition, compared with a metamaterial structure layer or another mechanical part disposed on an aperture surface with a relatively large area, the lens unit 20 disposed in the side region requires a relatively small area and has relatively low costs. This helps reduce manufacturing costs of the antenna apparatus 101 under a condition of implementing wide-angle scanning.

It should be understood that the lens unit 20 may be disposed in only one side region, or lens units 20 may be separately disposed in a plurality of side regions. This may be selected and set according to a broadening requirement that needs to be met.

For example, as shown in FIG. 4, the plurality of side regions may include the first side region 33a and the second side region 33b that are distributed in a width direction of the array structure 10. The first side region 33a and the second side region 33b may be disposed opposite to each other. Lens units 20 may be separately disposed in the first side region 33a and the second side region 33b. For example, a first lens unit 20a is disposed in the first side region 33a, and a second lens unit 20b is disposed in the second side region 33b. An electromagnetic wave signal radiated by the antenna apparatus 101 can be broadened in a width direction, to implement wide-angle scanning in the direction. In addition, symmetry of a radiation characteristic of the antenna apparatus 101 can be ensured. This is convenient for use and implementation.

Certainly, in some other examples, the plurality of side regions may alternatively include the third side region 33c and the fourth side region 33d that are distributed in a length direction of the array structure 10. The third side region 33c and the fourth side region 33d may be disposed opposite to each other. Lens units 20 may be separately disposed in the third side region 33c and the fourth side region 33d, so that an electromagnetic wave radiated by the antenna apparatus 101 can be broadened in a length direction, to implement wide-angle scanning in the direction, and symmetry of radiation can be ensured.

In embodiments of this application, an example in which lens units 20 are disposed in the first side region 33a and the second side region 33b is used for description.

The lens unit 20 may be fastened to the reflection plate 70, or the lens unit 20 may be fastened to the radome 80, or in some other examples, the lens unit 20 may be fastened to another mechanical part of the antenna apparatus 101. In addition, after being fastened, the lens unit 20 may be located inside the radome 80, or the lens unit 20 may be located outside the radome 80.

As shown in FIG. 5, in the height direction of the array structure 10, two ends of the lens unit 20 may be respectively located on upper and lower sides of the radiating surfaces 111 of the plurality of radiating elements 11, that is, the lens unit 20 extends from the rear region 32 to the front region 31. In the height direction of the array structure 10, some lens units 20 are located below the radiating surfaces 111 of the radiating elements 11, some lens units 20 are opposite to the radiating surfaces 111, and some lens units 20 are located above the radiating surfaces 111 of the radiating elements 11. In this way, an electromagnetic wave signal radiated by the radiating element in a side direction can better pass through the lens unit, thereby further implementing wide-angle scanning.

Two ends of the lens unit 20 are respectively located on upper and lower sides of the radiating surfaces 111 of the plurality of radiating elements 11. In an embodiment, in the height direction of the array structure 10, an end that is of the lens unit 20 and that is located above the radiating surface 111 is a top surface of the lens unit 20, and an end that is of the lens unit 20 and that is located below the radiating surface 111 is a bottom surface of the lens unit 20. A distance between the top surface of the lens unit 20 and the radiating surfaces 111 of the plurality of radiating elements 11 may be 0.15 to 1.0 time a wavelength. The wavelength is a band of an electromagnetic wave signal that can be radiated or received by the radiating element 11.

A distance between the bottom surface of the lens unit 20 and the radiating surfaces 111 of the plurality of radiating elements 11 may also be 0.15 to 1.0 time the wavelength, so that an electromagnetic wave signal radiated by the radiating element 11 in a side direction can well pass through the lens unit 20, thereby further facilitating wide-angle scanning, and more effectively using energy of the electromagnetic wave radiated by the radiating element 11 in the side direction.

Certainly, in some other examples, in the height direction of the array structure 10, a plurality of other distribution manners may be used between the lens unit 20 and the radiating surface 111 of the radiating element 11. For example, in the height direction, the lens unit 20 may be located above the radiating surface 111 of the radiating element 11. Alternatively, some lens units 20 may be located above the radiating surface 111 of the radiating element 11, and some lens units 20 may be opposite to the radiating surface 111.

In an embodiment, the lens unit 20 may include a dielectric lens. For example, the lens unit 20 may be an optical lens made of a dielectric material such as glass or plastic. For example, the lens unit 20 may be a glass lens, a plastic lens, or the like. Costs are low, and implementation and manufacturing are easy.

A shape of a cross section (a cross section formed in a height direction) of the lens unit 20 may be a quasi-linear shape, and an optical axis of the lens unit 20 may be parallel to the radiating surface 111 of the radiating element 11, so that an extension direction of the lens unit 20 is perpendicular to the radiating surface 111 of the radiating element 11. Alternatively, a shape of a cross section of the lens unit 20 may be another regular or irregular pattern. For example, the shape of the cross section of the lens unit 20 may be an arc, and an optical axis of the lens unit 20 may be inclined to the radiating surface 111 of the radiating element 11.

Certainly, in some other examples, with reference to FIG. 4 and FIG. 5, shapes of cross sections of some lens units 20 may be a quasi-linear shape, extension directions of the some lens units 20 are perpendicular to the radiating surface 111 of the radiating element 11, and shapes of cross sections of remaining lens units 20 may be an arc.

The lens unit 20 may be an entire dielectric lens. For example, the lens unit 20 is an entire glass lens, and may completely cover the array structure 10 in the length direction of the array structure 10 (as shown in FIG. 4). In other words, a dimension of the lens unit 20 in the length direction may be greater than or equal to a dimension of the array structure 10 in the length direction. In the length direction, the lens unit 20 can completely cover an outer side of the array structure 10, to fully utilize energy of electromagnetic waves radiated by the plurality of radiating elements 11 in the array structure 10 in a side direction. This helps further improve a broadening effect of the antenna apparatus 101, to implement scanning at a wider angle.

Alternatively, the lens unit 20 may include a plurality of lens substructures, and each lens substructure may be a dielectric lens. In other words, the lens unit 20 is a structure including a plurality of dielectric lenses. For example, the lens unit 20 includes a plurality of glass lenses.

The plurality of lens substructures may be distributed in the length direction of the array structure 10 and spaced from each other, and at least some lens substructures are opposite to the radiating element 11, to ensure that an electromagnetic wave signal radiated by the radiating element 11 is radiated through the lens substructure, or an electromagnetic wave signal is received by the radiating element 11 through the lens substructure. Under a condition of implementing wide-angle scanning, this helps reduce a size of the lens unit 20, and helps reduce costs, a weight, and the like.

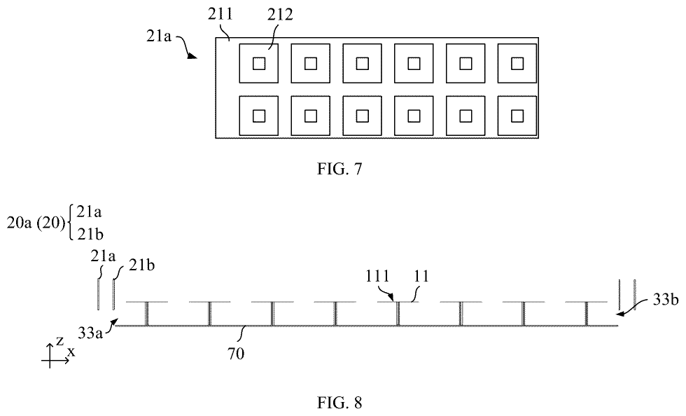

FIG. 6 is a diagram of a structure of another antenna apparatus according to an embodiment of this application. FIG. 7 is a diagram of a structure of a lens unit in another antenna apparatus according to an embodiment of this application. FIG. 8 is a schematic side view of another antenna apparatus according to an embodiment of this application.

Alternatively, in another possible implementation, the lens unit 20 may include an electromagnetic metamaterial layer, that is, the lens unit 20 is a structure that includes the electromagnetic metamaterial layer and that can implement an optical characteristic of a lens. For example, as shown in FIG. 6, the lens unit 20a located in the first side region 33a includes an electromagnetic metamaterial layer 21a and an electromagnetic metamaterial layer 21b.

An electromagnetic metamaterial is a material whose structural composition is manually designed and whose properties are derived from a precise geometric structure and a size of the electromagnetic metamaterial. A size of a microstructure in the material is smaller than a wavelength that the microstructure acts on. The electromagnetic metamaterial has excellent electromagnetic characteristics. For example, there is a wave-absorbing metamaterial in the related technology. When an electromagnetic wave is incident to the wave-absorbing metamaterial, the material presents a complete absorption characteristic because the electromagnetic wave is neither reflected nor transmitted. The wave-absorbing metamaterial also opens a new idea for a hidden design of the antenna due to perfect electromagnetic wave absorption performance of the wave-absorbing metamaterial.

In this example, a structure, a composition material, and the like of the electromagnetic metamaterial may be designed, so that the electromagnetic metamaterial can form the lens unit 20, and transmit and refract an electromagnetic wave signal. In this way, an electromagnetic wave beam is broadened, and wide-angle scanning is implemented. In addition, the electromagnetic metamaterial layer may have relatively low costs and a relatively light weight. This helps reduce a weight and costs of the antenna apparatus 101.

As shown in FIG. 7, the electromagnetic metamaterial layer 21a is used as an example. The electromagnetic metamaterial layer 21a may include a substrate 211, and a plurality of metamaterial structure patterns 212 are formed on the substrate 211. The plurality of metamaterial structure patterns 212 may be arranged on the substrate 211 in an array arrangement manner. For example, a characteristic of the electromagnetic metamaterial layer 21a may be adjusted by adjusting geometric parameters such as a shape, a size, and an arrangement manner of the metamaterial structure pattern 212, to implement a wide-angle scanning effect.

It should be noted that, in embodiments of this application, geometric parameters such as a shape and a size of the metamaterial structure pattern 212 on the electromagnetic metamaterial layer are not limited, and may be selected and set according to an actual requirement. For example, as shown in FIG. 7, the metamaterial structure pattern 212 may be a square. Certainly, in some other examples, the metamaterial structure pattern 212 may alternatively be another regular or irregular pattern.

Each lens unit 20 may include one or more electromagnetic metamaterial layers, to improve flexibility of setting a structure of the lens unit 20, so as to meet different design requirements and application scenarios. For example, with reference to FIG. 6 and FIG. 8, each lens unit 20 (using the first lens unit 20a as an example) may include two electromagnetic metamaterial layers. For example, the first lens unit 20a includes the electromagnetic metamaterial layer 21a and the electromagnetic metamaterial layer 21b.

When there are a plurality of electromagnetic metamaterial layers, the plurality of electromagnetic metamaterial layers may be stacked in the width direction of the array structure 10, and metamaterial structure patterns 212 on the plurality of electromagnetic metamaterial layers may be the same or different. Alternatively, metamaterial structure patterns 212 on some electromagnetic metamaterial layers may be the same, and metamaterial structure patterns 212 on some electromagnetic metamaterial layers may be different.

In embodiments of this application, an example in which the lens unit 20 includes two stacked electromagnetic metamaterial layers is used for description.

A shape of a cross section (a cross section formed in a height direction) of each electromagnetic metamaterial layer may be a quasi-linear shape. For example, as shown in the electromagnetic metamaterial layer 21a in FIG. 8, an extension direction of the electromagnetic metamaterial layer 21a is perpendicular to the radiating surface 111 of the radiating element 11, so that an overall extension direction of the formed lens unit 20 is perpendicular to the radiating surface 111 of the radiating element 11.

Alternatively, a shape of a cross section of each electromagnetic metamaterial layer may be another regular or irregular pattern, for example, may be an arc.

Certainly, in some other examples, shapes of cross sections of some electromagnetic metamaterial layers may be a quasi-linear shape, extension directions of the some electromagnetic metamaterial layers may be perpendicular to the radiating surface 111 of the radiating element 11, and shapes of cross sections of remaining electromagnetic metamaterial layers may be an arc.

It should be understood that the lens unit 20 may be an entire electromagnetic metamaterial layer, or may be formed by stacking a plurality of entire electromagnetic material layers. The electromagnetic material layer may completely cover the array structure 10 in a length direction (as shown in FIG. 6), so that the entire lens unit 20 covers the array structure 10 in the length direction. In other words, a dimension of each electromagnetic metamaterial layer in the length direction may be greater than or equal to the dimension of the array structure 10 in the length direction. In the length direction, the electromagnetic metamaterial layer completely covers the outer side of the array structure 10, to fully utilize energy of electromagnetic waves radiated by the plurality of radiating elements 11 in the array structure 10 in a side direction. This helps further improve a broadening effect of the antenna apparatus 101, to implement scanning at a wider angle.

Alternatively, the lens unit 20 may include a plurality of lens substructures. Each lens substructure includes one electromagnetic metamaterial layer or a plurality of electromagnetic metamaterial layers that are stacked. The plurality of lens substructures are distributed in the length direction of the array structure 10 and spaced from each other, and at least some lens substructures are opposite to the radiating element 11. This helps further reduce costs and a weight under a condition of implementing wide-angle scanning.

In the description of embodiments of this application, it should be noted that, unless otherwise explicitly stipulated and restricted, terms “installation”, “connecting”, and “connection” should be understood broadly, which, for example, may be a fixed connection, or may be an indirect connection via a medium, or may be internal communication between two components, or may be an interactive relationship between two components. One of ordinary skilled in the art may understand meanings of the foregoing terms in embodiments of this application based on cases. The terms such as “first”, “second”, “third”, “fourth”, and the like (if any) are intended to distinguish between similar objects but do not necessarily describe an order or sequence.

Finally, it should be noted that the foregoing embodiments are merely used to describe the technical solutions in embodiments of this application, but not to limit the technical solutions. Although embodiments of this application are described in detail with reference to the foregoing embodiments, one of ordinary skilled in the art should understand that the technical solutions recorded in the foregoing embodiments may still be modified, or some or all of technical features thereof may be equivalently replaced. However, these modifications or replacements do not cause the essence of corresponding technical solutions to depart from the scope of the technical solutions in embodiments of this application.

1. An antenna apparatus, comprising:
a lens unit;
a plurality of radiating elements spaced from each other and arranged in an array to form an array structure having at least four columns, wherein each column comprises at least one radiating element; and
a plurality of side regions located on a circumferential outer side of the array structure, wherein the lens unit is disposed in at least one of the plurality of side regions.

2. The antenna apparatus according to claim 1, wherein in a height direction of the array structure, two ends of the lens unit are respectively located on upper and lower sides of radiating surfaces of the plurality of radiating elements.

3. The antenna apparatus according to claim 1, wherein the plurality of side regions comprise a first side region and a second side region opposite to each other; and
the first side region and the second side region are distributed in a width direction of the array structure, and lens units are separately disposed in the first side region and the second side region.

4. The antenna apparatus according to claim 3, wherein the lens unit comprises a dielectric lens.

5. The antenna apparatus according to claim 3, wherein the lens unit comprises an electromagnetic metamaterial layer.

6. The antenna apparatus according to claim 5, further comprising a plurality of electromagnetic metamaterial layers arranged in a stack.

7. The antenna apparatus according to claim 3, wherein the lens unit completely covers the array structure in a length direction of the array structure.

8. The antenna apparatus according to claim 3, wherein the lens unit comprises a plurality of lens substructures
that are distributed in a length direction of the array structure and spaced from each other, and at least a part of the lens substructures are opposite to the radiating element.

9. The antenna apparatus according to claim 1, wherein in a height direction of the array structure, a distance between a top surface of the lens unit and a radiating surface of the radiating element and a distance between a bottom surface of the lens unit and the radiating surface of the radiating element each are 0.15 to 1.0 time a wavelength.

10. The antenna apparatus according to claim 1, further comprising a reflection plate, wherein the radiating element is disposed on the reflection plate.

11. The antenna apparatus according to claim 1, further comprising a radome covering the array structure.

12. A communication device, comprising:
at least a pole,
a grounding apparatus, and
an antenna apparatus, comprising:
a lens unit;
a plurality of radiating elements spaced from each other and arranged in an array to form an array structure comprising at least four columns, wherein each column comprises at least one radiating element; and
a plurality of side regions located on a circumferential outer side of the array structure, wherein the lens unit is disposed in at least one of the plurality of side regions, and
the antenna apparatus is disposed on the pole, and the antenna apparatus is electrically connected to the grounding apparatus.

13. The communication device according to claim 12, wherein in a height direction of the array structure, two ends of the lens unit are respectively located on upper and lower sides of radiating surfaces of the plurality of radiating elements.

14. The communication device according to claim 12, wherein the plurality of side regions comprise a first side region and a second side region opposite to each other; and
the first side region and the second side region are distributed in a width direction of the array structure, and lens units are separately disposed in the first side region and the second side region.

15. The communication device according to claim 14, wherein the lens unit comprises a dielectric lens.

16. The communication device according to claim 14, wherein the lens unit comprises an electromagnetic metamaterial layer.

17. The communication device according to claim 16, the lens unit further comprises a plurality of electromagnetic metamaterial layers arranged in a stack.

18. The communication device according to claim 14, wherein the lens unit completely covers the array structure in a length direction of the array structure.

19. The communication device according to claim 14, wherein the lens unit comprises a plurality of lens substructures that are distributed in a length direction of the array structure and spaced from each other, wherein at least a part of the lens substructures are opposite to the radiating element.

20. The communication device according to claim 12, wherein in a height direction of the array structure, a distance between a top surface of the lens unit and a radiating surface of the radiating element and a distance between a bottom surface of the lens unit and the radiating surface of the radiating element each are 0.15 to 1.0 time a wavelength.
